(19) United States
(12) Patent Application Publication
(10) Pub. No.: US 2010/0087305 A1
(43) Pub. Date: Apr. 8, 2010

(54) Method and Apparatus For Making A Wave Top Bag

(75) Inventors: Bradley J. Schmoll, Appleton, WI (US); Charles H. Saunder, Appleton, WI (US); Paul A. Johnson, Menasha, WI (US)

Correspondence Address: GEORGE R CORRIGAN, 5 BRIARCLIFF COURT, APPLETON, WI, 54915, US

(73) Assignee: CMD Corporation, Appleton, WI (US)

(21) Appl. No.: 12/245,104

(22) Filed: Oct. 3, 2008

(51) Int. Cl. B31B 1/16; B31B 1/26; B65D 30/20

(52) U.S. Cl. 493/235; 493/267; 383/37; 493/239

(57) ABSTRACT

A method and apparatus for making rolls of wave cut bags, and a roll of bags is disclosed. A film is weakened along a generally straight line in a generally cross machine direction. The film is also weakened a wave shape, and the wave shape weakenings are alternated with the straight line weakenings. The film is folded in a cross machine direction, and the straight line weakenings are separated to form bottoms of adjacent bags. The bottoms of adjacent bags are preferably overlapped, although they need not be. The wave shaped weakenings are preferably separated (although they need not be) to form wave shaped tops of a adjacent bags. If separated, the wave shaped tops have a longer portion and a shorter portion, and the longer portion is between, in the machine direction, the longer and shorter portion of the adjacent wave shaped top.

### FIELD OF THE INVENTION

The present invention relates generally to the art of rolls of bags, and equipment and methods to make rolls of bags. More specifically, it relates to wave top bags, and equipment and methods to make rolls of wave top bags from film such as flattened blown film tubes.

### BACKGROUND OF THE INVENTION

There are many different types of bags with varied uses, and many different machines and methods to make such bags. One example of a bag is a trash bag, such as that used for kitchen trash cans. A known type of trash bag is a wave top (or wave cut) bag. A wave top bag has portions or lobes of the top that, when the bag is upright, are taller than the remaining portions, and can be used to tie the bag shut. FIG. 1 shows a wave top bag.

Many trash bags are made using film that forms a flattened tube by imparting seals and perforations in a cross machine direction across the width of the film to form bags from the film. Cross machines direction, as used herein, includes the direction perpendicular to the direction the film moves as it travels through a bag machine. After the bags are sealed and perforated, they are typically folded (usually twice) in the cross machine direction, thus reducing the width of the bag. Adjacent bags may be separated and overlapped as made, or separated by the end user, in either case by pulling apart adjacent bags at the perforations between bags.

When the end user separates bags, the formed bags are sold in rolls of bags connected end to end. The rolls of end-to-end connected trash bags are packaged in boxes or suitable containers for distribution. The end user pulls the bag at the dispensing end, to separate the bag and to unwind the roll, thus leaving the subsequent bag ready for dispensing. If the separation is done during the manufacturing of the bags, then as the user removes the end bag, the subsequent bag, which overlaps the end bag, is pulled into position for dispensing.

It is desirable to reduce costs by reducing the amount of film used to make bags. Thus, the perforations are formed immediately adjacent and parallel to each seal. Also, wave cut bags are made top-to-top and bottom-to-bottom so that the lobes on a first bag are opposite the lobes on a subsequent bag, thus resulting in no waste. Thus, wave top bags can be made by repeatedly forming two closely spaced bottom seals, and perforating between the bottom seals. The wave top perforation is placed midway between a first pairs of seals and a second pair of seals, and may be made using a die-cut or rotary knife.

After forming, the bags may be folded, separated and overlapped. Bag machines that overlap subsequent bags with straight line tops and bottoms are well known. For example, U.S. Pat. No. 5,390,875, Gietman, Jr., et al. (hereby incorporated by reference) shows a rotary overlap bag machine that receives a film of formed bags, and separates and/or overlaps bags to form a roll of bags. Such equipment typically detects the perforations between bags using a spark gap detector, and separates and/or overlaps in response to that detection. Straight line perforations are readily detected, even when the bag is folded twice in the cross machine direction, as is typically the case.

Overlapping wave top bags has posed challenges, because the perforation is not straight. When the wave top bag is folded, the perforations are not aligned, and thus it is hard to detected the spark through multiple layers of the bag. Also, when folded wave top perforations have a portion or lobe that is a single layer, and thus not as stiff as multiple layers. It can be difficult to manipulate the single layer when trying to overlap wave tops.

U.S. Pat. No. 7,048,224, Allgood, (hereby incorporated by reference) addresses the difficulty by placing a sensor between layers of adjacent film. However, such an arrangement require the folded film to be precisely guided so that one layer is on either side of the sensor, and so that the sensor does not interfere with the film moving through the machine.

Accordingly, a wave top bag, made with overlap and without needing a sensor between layers of film is desirable.

### SUMMARY OF THE PRESENT INVENTION

According to a first aspect of the invention, a method of making wave cut bags includes moving a film from an upstream direction to a downstream machine direction. The film is weakened along a generally straight line in a generally cross machine direction. The film is also weakened a wave shape, and the wave shape weakenings are alternated with the straight line weakenings. The film is folded in a cross machine direction, and the straight line weakenings are separated to form bottoms of adjacent bags. The bottoms of adjacent bags are overlapped. The wave shaped weakenings are separated to form wave shaped tops of a adjacent bags. The wave shaped tops have a longer portion and a shorter portion, and the longer portion is between, in the machine direction, the longer and shorter portion of the adjacent wave shaped top.

According to a second aspect of the invention, a bag machine includes an infeed section, a perforating section, a folding section and a separating section. The infeed section receives the film, and the film moves through the infeed section from an upstream direction to a downstream machine direction. The perforating section receives the film from the infeed section and includes a straight line perforator, and a wave shape perforator. The wave shape perforator is operated alternately with the straight line perforator. The separating section includes a straight line separator with a straight line overlapper, and a wave shape separator without a wave shape overlapper.

According to a third aspect of the invention a roll of bags has a dispensing end and an inner end, and includes bags having generally straight line bottoms and having wave shaped tops. The wave shaped tops have a longer portion and a shorter portion. A first sub group of the bags have the wave shaped top closer to the dispensing end than to the inner end. A second sub group has the straight line bottom wave closer to the dispensing end than to the inner end. Bags in the roll are alternately from the first group and the second group such that the wave shaped tops are adjacent another wave shaped top, and straight line bottoms are adjacent another straight line bottom. Adjacent straight line bottoms are overlapping with one another. The longer portion is between, in the machine direction, the longer and shorter portion of the adjacent wave shaped top.

According to a fourth aspect of the invention a method of making wave top bags includes weakening the film in a generally straight line in a cross machine direction and alternately weakening the film in a wave shape. The film is folded in the cross machine direction. The film is separated along the straight line weakenings to form the bottoms of adjacent bags. The bottoms of adjacent bags are overlapped, and the wave shaped weakenings are not separated to leave a first bag attached to an adjacent second bag.

According to a fifth aspect of the invention a bag machine includes an infeed section, a perforating section, a folding section, and a separating section. The film moves through the infeed section from an upstream direction to a downstream machine direction. The perforating section includes a straight line perforator and a wave shape perforator that are operated alternately. The separating section includes a straight line separator with a straight line overlapper, and no wave shape separator.

According to a sixth aspect of the invention a roll of bags, roll of bags has a dispensing end and an inner end, and includes bags having generally straight line bottoms and having wave shaped tops attached to adjacent bags. The wave shaped tops have a longer portion and a shorter portion. A first sub group of the bags have the wave shaped top closer to the dispensing end than to the inner end. A second sub group has the straight line bottom wave closer to the dispensing end than to the inner end. Bags in the roll are alternately from the first group and the second group such that the wave shaped tops are adjacent another wave shaped top, and straight line bottoms are adjacent another straight line bottom. Adjacent straight line bottoms are overlapping with one another.

Folding is performed before or after separating the wave shaped weakenings in various embodiments.

Separating the wave shaped weakenings includes feeding the film to a conveyor nip, and/or separating the straight line weakenings includes feeding the film to a rotary overlap section in other embodiments.

The wave top longer portion is closer to the shorter portion of the adjacent wave shaped top than to the longer portion of the adjacent wave shaped top in other embodiments.

Separating the wave shaped weakenings is done with sufficient force to separate adjacent bags at wave shaped the weakening, but without extra force to further create a gap in the machine direction between adjacent bags, in various embodiments.

Separating the straight line weakenings is done before or after separating the wave shaped weakenings in some embodiments.

Other principal features and advantages of the invention will become apparent to those skilled in the art upon review of the following drawings, the detailed description and the appended claims.

### BRIEF DESCRIPTION OF THE DRAWINGS

FIG. 1 is a wave top bag, such as that known in the prior art;

FIG. 2 is a plurality of wave top bags, before separation, in accordance with the preferred embodiment;

FIG. 3 is the plurality of wave top bags of FIG. 2, after separation;

FIG. 4 is the plurality of wave top bags of FIG. 3, with a single cross machine direction fold;

FIG. 5 is a bag machine in accordance with the preferred embodiment; and

FIG. 6 is the plurality of wave top bags of FIG. 3, with two cross machine direction folds.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular roll of bags, and a particular bag machine, it should be understood at the outset that the invention may be implemented to make other rolls, and with other equipment. Roll of bags, as used herein, includes bags that are overlapped or not overlapped, and attached or separated.

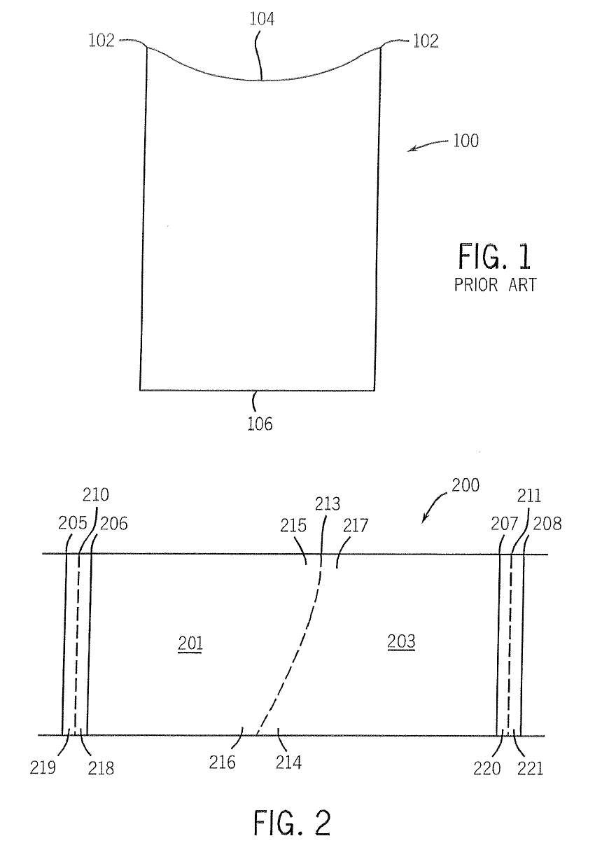

Generally, the invention provides for a roll of bottom-to bottom, top-to-top wave cut (or wave shaped top) bags, and the equipment and method used to make the bags. A wave top bag 100, such as a prior art bag, is shown in FIG. 1 and includes two longer portions or lobes 102, a shorter portion or lobe 104 (the bag, when flattened has two layers of film—the front of the bag and the back of the bag—and thus a second shorter portion is behind portion 104) and a straight bottom 106. The longer portion is considered longer than the shorter because the longer portion extends farther from the bottom of the bag as shown in FIG. 1.

The prior art bag is shown to establish terminology when describing the present invention. The present invention may be implemented in such a way that individual bags are not discernible from prior art bags. Top of a bag, as used herein, includes the portion of the bag through which refuse or other material being placed inside the bag passes. Bottom of a bag, as used herein, is the end of the bag that is not open for insertion of material into the bag. Wave cut bags, as used herein, includes bags with a wave shaped top. Wave shaped top, as used herein, includes a bag with an opening that is not substantially straight. Straight line bottom, as used herein, means a bottom that is generally in a straight line. Generally in a straight line, as used herein, includes substantially or mostly in a straight line, but does not require completely in a straight line. Generally in a direction, as used herein, includes substantially or mostly in a direction, but does not require completely in a direction, nor in a straight line. Extends farther or not as far from the bottom of the bag, as used herein, refers to the distance along a line parallel to the machine direction from a portion or point on a wave top to the bottom of the bag being greater or lesser.

The invention provides for separating and overlapping wave cut bags along their straight bottoms, and merely separating along their wave cut tops, without an added steps of overlapping the wave tops. The separation is done such that the gap between the separated film is small, and thus when subsequently folded (twice in the cross direction) all but a small portion of the bags have at least eight layers of film, and the overlapped portions have sixteen layers of film). The wave cut is thus easier to process than if the separation is done by pulling them apart a greater distance than the length of the lobes. Moreover, because there is no separate step of overlapping the wave cut top, there is no need to process the single layers.

A portion of a roll of bags 200 is shown in FIG. 2. Roll 200 is shown after a single fold, and before a second fold, before separating, and before overlapping the bottoms. After a single fold roll 200 has four layers of film. Roll 200 includes adjacent bags 201 and 202 formed from seals 205-208, from straight line perforations or weakenings 210-211, and from wave cut perforation or weakening 213. A straight line bottom 218 of bag 201 is formed by seal 206 and perforation 210, and is adjacent a straight line bottom 219 of an adjacent bag (not fully shown). A straight line bottom 220 of bag 202 is formed by seal 207 and perforation 211, and is adjacent a straight line bottom 221 of an adjacent bag (not fully shown). The wave shaped tops of bags 201 and 202 are adjacent and formed by perforation 213. As may be seen, a longer portion 215 of bag 201 is formed with a shorter portion 217 of bag 203. Likewise, a longer portion 214 of bag 202 is formed with a shorter portion 216 of bag 201. Bags 201 and 202 are attached at perforation 213 in FIG. 2.

Adjacent bags, as used herein, includes successive bags, as they are formed, or in a roll, and include overlapped or non-overlapped bags, and separated or attached bags. Straight line weakenings, as used herein, includes a weakening or perforation along a generally straight line. Wave shaped weakenings, as used herein, includes a weakening or perforation along a line that is not substantially in the cross machine direction and/or not substantially in a straight line when the bag is unfolded. A bag is attached to a second bag, as used herein, when the perforation or line of weakness between adjacent bags is not broken.

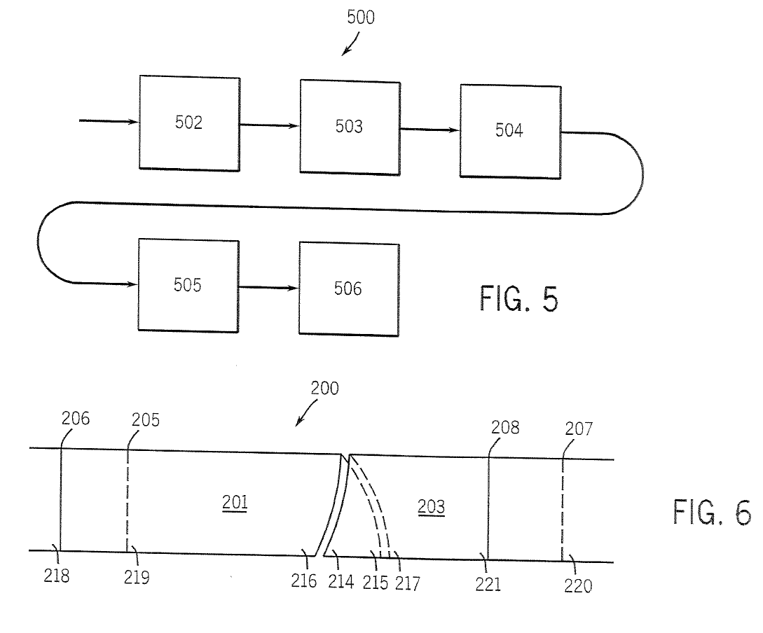

The preferred embodiment provides for forming the bags using a bag machine 500, as shown in FIG. 5. Bag machine 500 include an infeed and sealing section 502, a folding section 503, a wave shaped perforating section 504, a second folding section 505 and a winding section 506. The arrows show the direction the film travels—from the upstream direction to the downstream machine direction.

Bag machine section, as used herein, includes a physical or functional section of a bag machine that may be in a single location, or distributed over a plurality of discontinuous locations. Infeed section, as used herein, includes a includes a bag machine section that receives film. Sealing section, as used herein, includes a bag machine section that imparts seals and can impart perforations or lines of weakness to the film. Folding section, as used herein, includes a bag machine section that folds film in the cross machine direction (i.e, along a line from the top of the bag to the bottom of the bag). Perforating section, as used herein, includes a bag machine section that imparts a perforation or line of weakness to a film. Winding section, as used herein, includes a bag machine section that winds, and can, but need not, include equipment to overlap adjacent bags.

Infeed section and sealing section 502 is a rotary bag machine, such as that shown in U.S. Pat. No. 7,326,162, Sauder, et al. (hereby incorporated by reference) or CMD 5213 Rotary Bag Machine®, in the preferred embodiment. Section 502 is used to make the straight line seals and perforations. Alternatives provides for using advanced bag machines that create the seal and perforation at the same time, such as that shown in US Patent Application 2008-0093018 A1 (Selle), hereby incorporated by reference. Such embodiment provide that section 502 includes a straight line perforator. Straight line perforator, as used herein, includes a perforator section, or portion thereof, that forms straight line weakenings or perforation. Weakening the film, as used herein, includes creating a line of weakness in the film at which adjacent bags can be separated by machine or by the user.

After the straight line seals and perforations are formed, the bag is folded once by folding section 503. Section 503 can be a conventional folder and/or can be a stand alone folder, or integrated with the sealing section.

The film is then moved to wave shaped perforating section 504 where a wave cut is made to the bags. The wave cut is preferably formed equidistant between bag bottoms can be made using a die cut mounted on a cam, or in any convention manner. Also, the wave cut can be made before the film reaches folding section 502. In either case wave shape perforator 502 is part of a perforating section that includes the straight line perforator. However, in the embodiment of FIG. 5, the perforating section is distributed over several locations. Wave shape perforator, as used herein, includes a perforator section, or portion thereof, that forms wave shaped weakenings or perforation.

The film is then moved to folding section 505, which may be a conventional folder, and/or be part of other sections, such as part of winding section 506.

Winding section 506 receives the twice folded film and separates perforations, and overlaps straight line bottoms. Because it also separates bags along perforations or weaknesses, winding section 506 is also called a separating section. Separating section, as used herein, includes, a includes a bag machine section that separates adjacent bags along perforations or lines of weakness.

Winding/separating section 506 is in accordance with U.S. Pat. No. 5,390,875, a CMD model 4213RO® winder, and/or US Patent Application 20080067279A1, Selle, (hereby incorporated by reference) in various embodiments. Some embodiments provide that it is not necessary to add a wave shape separator, and a single separator can separate both tops and bottoms. Preferably it includes a rotary overlap section. Rotary overlap section, as used herein, includes a bag machine section that overlaps adjacent bags using a rotary motion or rotary device.

The rotary overlap section is a straight line separator and a straight line overlapper, in the preferred embodiments because it both separates and overlaps the straight line perforations. Other embodiments provide for physically separated overlappers and separators. Straight line separator, as used herein, includes a separator section, or portion thereof, that separated straight line weakenings or perforation. Straight line overlapper, as used herein, includes an overlap section, or portion thereof, that overlaps straight line separations.

The prior art winders are modified, if needed, to have a conveyor nip be a wave shape separator to separate the wave cut, but without a wave shape overlapper. Wave shape separator, as used herein, includes a separator section, or portion thereof, that separated wave shaped weakenings or perforation. Conveyor nip, as used herein, includes a nip with at least one driven roll that drives the film.

The conveyor nip may be before the straight line separator, or after the straight line separator. Separating the wave cut after the bottoms are overlapped can make it easier to feed the wave cut through the overlapper (because there are not wave shaped leading ends of bags detached from the trailing end of preceding bags). The conveyor nip may be an existing nip, such as that used to feed the winding section, or an added nip. It may be operated in a known manner to separate the wave shaped perforations.

In operation the straight line perforations are sensed in a conventional manner, and separating section 506 acts on them in a conventional manner. Thus, the bottoms of the bags are separated and overlapped.

As noted above, it is difficult to sense a wave shaped perforation after folding. Thus, the separation of wave shaped perforations is preferably done based on distance/time between straight line perforations. It can be based on a running average of time/distance between straight line perforations, the last few sensings, or other known control schemes such as proportional, PID, etc. In other words, the separation of wave shaped perforations is performed based on an expectation that the wave shaped perforation is midway between straight line perforations, and the relative ease of sensing straight line perforations. In any case, the straight line separator and the wave shaped separator are operated alternately, in that they operate on alternate perforations. Operated alternately, as used herein, includes operating one separator on a perforation or weakness, and then the other on a subsequent perforation or weakness. It can also include a single piece of equipment operate alternately to separate straight bottoms and then wave tops.

Wave shaped separator applies sufficient force to separate bags 201 and 202 at perforation 213, but preferably uses the minimum force (or difference in speed at the conveyor nip) to reliably do so, i.e., without extra force to further create a gap in the machine direction between adjacent bags, so that the gap between bags 201 and 202 remains at a minimum. One alternative provides for not separating the wave shaped weakenings, such that the user separates every other bag (attached at the wave tops), and the alternate bags are separated with overlapped bottoms.

When the above method and bag machine are used, a roll of bags of formed that is bottom-to-bottom and top-to-top, with overlapped bottoms and separated tops. The lobes of the tops are left adjacent one another, to add support and help with winding the roll and dispensing bags.

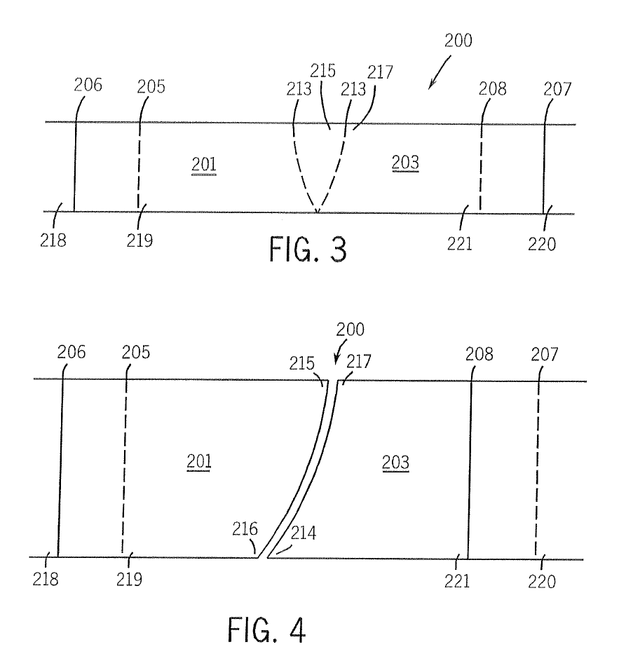

Turning now to FIG. 3, roll 200 and bags 201 and 203 of FIG. 2 are shown after the second folding, after separation at perforations 210 and 211, and after overlapping the bottoms of the bags. Because roll 200 is folded twice, it now has eight layers of film (and the overlapped portions have 16 layers of film).

Wave cut perforation 213 is still attached, and the left portion of perforation 213 is beneath the upper layer of folded bag 201 (thus it is dashed both as a perforation and because it is not visible). It can be seen that seal 206 and straight lined bottom 218 overlap seal 205 and straight lined bottom 219, and that seal 208 and straight lined bottom 221 overlap seal 207 and straight lined bottom 220. Thus, seals 205 and 207 are beneath the upper layer and are dashed because they are not visible (they are not perforations). As shown, bags 201 and 203 have not been separated along wave cut perforation 213. However, the invention is not limited to a particular order of events, and perforation 213 is shown attached for illustrative purposes.

Bags 201 and 202 are shown unfolded (once, so that a single fold remains) and separated along wave shaped perforation or weakness 213 in FIG. 4. Thus, each bag has hour layers of film, and there is a gap between bags 201 and 203. The overlapped portions have eight layers of film. The preferred embodiment provides that the bags are folded twice when the wave shaped perforations are separated, and when the roll is packaged and sold. However, the roll is shown unfolded (once) in FIG. 4 to show the wave shaped tops adjacent one another, with a slight gap there between. The wave shape tops are, as shown, adjacent one another. Wave shaped tops are adjacent a wave shaped top from an adjacent bag when the bags are touching, attached, or close to touching.

The separation between wave shaped cuts along what had been perforation 213 is done such that the gap between tops is small. Also no overlapping is performed. As described above, the separation can be done using a conveyor nip, or done using other techniques. As shown, longer portion 215 remains adjacent shorter portion 217 and shorter portion 216 remains adjacent longer portion 214. Also, longer portion 215 is between, in the machine direction, the longer and shorter portions 214 and 217 of the adjacent wave shape top of bag 203, and longer portion 214 is between, in the machine direction, the longer and shorter portions 216 and 215 of the adjacent wave shape top of bag 201. Between, in the machine direction, as used herein, refers to the longer portion being between them on a path only in the machine direction, and without regard to cross direction position.

Turning now to FIG. 6, the bags of FIG. 4 are shown with the second fold in the cross machine direction intact, such as after production and as typically sold. Thus, as in FIG. 4, the wave shaped tops are adjacent one another, with a slight gap there between, and without overlapping along the wave shaped tops. Also, as in FIG. 4, longer portion 215 is between, in the machine direction, the longer and shorter portions 214 and 217 of the adjacent wave shape top of bag 203, and longer portion 214 is between, in the machine direction, the longer and shorter portions 216 and 215 of the adjacent wave shape top of bag 201. As shown roll 200 has eight layers of film near the wave tops, except that there are four layers in the small gap where perforation 213 had been.

A completed roll follows the pattern set in FIG. 6, where, every other bag has its straight line bottom closer to the dispensing end, and its wave shaped top closer to the inner end. The alternate bags are disposed opposite, and have their straight line bottoms closer to the inner end, and their wave shaped tops closer to the dispensing end. Closer to the dispensing end than to the inner end, as used herein, refers to the distance following the bags in the roll (i.e., a spiral from the dispensing end to the inner end) being less to the dispensing end than to the inner end.

Numerous modifications may be made to the present invention which still fall within the intended scope hereof. Thus, it should be apparent that there has been provided in accordance with the present invention relating to rolls of bags and a method and apparatus for making bags and rolls of bags that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A method of making wave cut bags, comprising:
moving a film from an upstream direction to a downstream machine direction;
weakening the film in a generally straight line, and generally in a cross machine direction;
weakening the film in a wave shape, wherein the wave shape weakenings are alternated with the straight line weakenings;
folding the film in the cross machine direction;
separating the straight line weakenings to form the bottoms of adjacent bags;
overlapping the bottoms of adjacent bags formed from separating the straight line weakenings; and
separating the wave shaped weakenings to form wave shaped tops of a first bag and an adjacent second bag, wherein the wave shaped tops have a longer portion and a shorter portion and the longer portion extends farther from the bottom than the shorter portion, and the longer portion is between, in the machine direction, the longer and shorter portion of the adjacent wave shaped top.

2. The method of claim 1 wherein folding is performed after separating the wave shaped weakenings.

3. The method of claim 1 wherein folding is performed before separating the wave shaped weakenings.

4. The method of claim 1 wherein separating the wave shaped weakenings includes feeding the film to a conveyor nip.

5. The method of claim 4 wherein separating the straight line weakenings includes feeding the film to a rotary overlap section.

6. The method of claim 1 wherein separating the straight line weakenings includes feeding the film to a rotary overlap section.

7. The method of claim 1 wherein separating the wave shaped weakenings is done such that the wave top longer portion is closer to the shorter portion of the adjacent wave shaped top than to the longer portion of the adjacent wave shaped top.

8. The method of claim 1 wherein separating the wave shaped weakenings is done with sufficient force to separate adjacent bags at wave shaped the weakening, but without extra force to further create a gap in the machine direction between adjacent bags,

9. The method of claim 1 wherein separating the straight line weakenings is done after separating the wave shaped weakenings.

10. The method of claim 1 wherein separating the wave shaped weakenings is done after separating the straight line weakenings.

11. A bag machine, comprising:
an infeed section, where a film moves through the infeed section from an upstream direction to a downstream machine direction;
a perforating section, disposed to receive the film including a straight line perforator, and a wave shape perforator, wherein the wave shape perforator is operated alternately with the straight line perforator;
a folding section, disposed to receive the film; and
a separating section, disposed to receive the film, including a straight line separator with a straight line overlapper, and a wave shape separator without a wave shape overlapper.

12. The bag machine of claim 11 wherein the folding section is downstream of the wave shape separator.

13. The bag machine of claim 11 wherein the folding section is not downstream of the wave shape separator.

14. The bag machine of claim 11 wherein the wave shaped separator includes a conveyor nip.

15. The bag machine of claim 14 wherein the straight line separator includes a rotary overlap section.

16. The bag machine of claim 11 wherein the straight line separator includes a rotary overlap section.

17. A bag machine, comprising:
a straight line perforating means for forming a straight line perforation in a film moving from an upstream direction to a downstream machine direction;
a wave shape perforating means for forming wave shape perforations that alternate with the straight line perforations;
folding means for folding the film in a cross machines direction;
means for separating and overlapping the straight line perforation; and
means for separating the wave shape perforations to form wave shaped tops of a first bag and an adjacent second bag, wherein the wave shaped tops have a longer portion and a shorter portion and the longer portion extends farther from the bottom than the shorter portion, and the longer portion is between, in the machine direction, the longer and shorter portion of the adjacent wave shaped top.

18. The bag machine of claim 17 wherein the folding means is downstream of the means for separating the wave shape perforations.

19. The bag machine of claim 17 wherein the folding means is not downstream of the means for separating the wave shape perforations.

20. The bag machine of claim 17 wherein the means for separating the wave shape perforations includes a conveyor nip.

21. The bag machine of claim 20 wherein the means for separating the straight line perforations includes a rotary overlap means.

22. The bag machine of claim 17 wherein the means for separating the straight line perforations includes a rotary overlap means.

23. A roll of bags, wherein the roll has a dispensing end and an inner end, comprising a plurality of bags having generally straight line bottoms and having wave shaped tops, wherein:
the wave shaped tops have a longer portion and a shorter portion wherein the longer portion extends farther from the bottom than a shorter portion, and;
a first sub group of the plurality has the wave shaped top closer to the dispensing end than to the inner end;
a second sub group of the plurality has the straight line bottom wave closer to the dispensing end than to the inner end;
the roll is comprised of bags alternately from the first group and the second group such that the wave shaped top from a given bag is adjacent a wave shaped top from a first adjacent bag and the straight line bottom of the given bag is adjacent a straight line bottom from a second adjacent bag;
adjacent straight line bottoms are overlapping with one another; and
the longer portion is between, in the machine direction, the longer and shorter portion of the adjacent wave shaped top.

24. The roll of bags of claim 23, wherein the bags are folded along a line extending from the wave shaped top of the bag to the straight line bottom of the bag.

25. The roll of bags of claim 24, wherein the longer portion is closer to the shorter portion of the adjacent wave shaped top than to the longer portion the adjacent wave shaped top.

26. A method of making wave top bags, comprising:
moving a film from an upstream direction to a downstream machine direction;
weakening the film in a generally straight line, and generally in a cross machine direction;
weakening the film in a wave shape, wherein the wave shape weakenings are alternated with the straight line weakenings;
folding the film in the cross machine direction;
separating the straight line weakenings to form the bottoms of adjacent bags;
overlapping the bottoms of adjacent bags formed from separating the straight line weakenings; and
not separating the wave shaped weakenings to leave a first bag attached to an adjacent second bag.

27. A bag machine, comprising:
an infeed section, where a film moves through the infeed section from an upstream direction to a downstream machine direction;
a perforating section, disposed to receive the film including a straight line perforator, and a wave shape perforator, wherein the wave shape perforator is operated alternately with the straight line perforator;
a folding section, disposed to receive the film; and
a separating section, disposed to receive the film, including a straight line separator with a straight line overlapper, and no wave shape separator.

28. A bag machine, comprising:
a straight line perforating means for forming a straight line perforation in a film moving from an upstream direction to a downstream machine direction;
a wave shape perforating means for forming wave shape perforations that alternate with the straight line perforations;
folding means for folding the film in a cross machines direction;
means for separating and overlapping the straight line perforations without separating the wave shape perforations to form attached wave shaped tops of a first bag and an adjacent second bag, and separated and overlapped bottoms.

29. A roll of bags, wherein the roll has a dispensing end and an inner end, comprising a plurality of bags having generally straight line bottoms and having wave shaped tops, wherein:
a first sub group of the plurality has the wave shaped top closer to the dispensing end than to the inner end;
a second sub group of the plurality has the straight line bottom wave closer to the dispensing end than to the inner end;
the roll is comprised of bags alternately from the first group and the second group and the wave shaped top from a given bag is adjacent and attached to a wave shaped top from a first adjacent bag and the straight line bottom of the given bag is adjacent and overlapping a straight line bottom from a second adjacent bag
adjacent straight line bottoms are overlapping with one another; and
the longer portion is between, in the machine direction, the longer and shorter portion of the adjacent wave shaped top.
